(19) United States
(12) Patent Application Publication
(10) Pub. No.: US 2024/0168234 A1
(43) Pub. Date: May 23, 2024

(54) FABRIC NETWORK MODULES

(71) Applicant: Panduit Corp., Tinley Park, IL (US)

(72) Inventors: Jose M. Castro, Naperville, IL (US); Richard J. Pimpinella, Prairieville, LA (US); Bulent Kose, Burr Ridge, IL (US); Yu Huang, Orland Park, IL (US)

(73) Assignee: Panduit Corp., Tinley Park, IL (US)

(21) Appl. No.: 17/989,194

(22) Filed: Nov. 17, 2022

(51) Int. Cl. G02B 6/35; G02B 6/38

(52) U.S. Cl. CPC G02B 6/3544; G02B 6/3885

(57) ABSTRACT

An apparatus having a plurality of multifiber connector interfaces, where some of these multifiber connector interfaces can connect to network equipment in a network using multifiber cables, has an internal mesh implemented in two tiers. The first is configured to rearrange and the second is configured to recombine individual fiber of the different fiber groups. The light path of each transmitter and receiver is matched in order to provide proper optical connections from transmitting to receiving fibers and complex arbitrary network topologies can be implemented with at least 1/N less point to point interconnections, where N=number of channels per multifiber connector interface.

### FIELD OF INVENTION

Disclosed is an apparatus and method to improve the scalability of Data Center networks using mesh network topologies, switches of various radixes, tiers, and oversubscription ratios. The disclosed apparatus and method reduce the number of manual network connections while simplifying the cabling installation, improving the flexibility and reliability of the data center.

### BACKGROUND

The use of optical fiber for transmitting communication signals has been rapidly growing in importance due to its high bandwidth, low attenuation, and other distinct advantages, including radiation immunity, small size, and lightweight. Datacenter architectures using optical fiber are evolving to meet the global traffic demands and the increasing number of users and applications. The rise of cloud data centers, particularly the hyperscale cloud, has significantly changed the enterprise information technology (IT) business structure, network systems, and topologies. Moreover, cloud data center requirements are impacting technology roadmaps and standardization.

The wide adoption of server virtualization and advancements in data processing and storage technologies have produced the growth of East-West traffic within the data center. Traditional three-tier switch architectures comprising Core, Aggregation, and Access (CAA) layers cannot provide the low and equalized latency channels required for East-West traffic. Moreover, since the CAA architecture utilizes spanning tree protocol to disable redundant paths and build a loop-free topology, it underutilizes the network capacity.

The Folded Clos network (FCN) or Spine-and-Leaf architecture is a better-suited topology to overcome the limitation of the three-tier CAA networks. A Clos network is a multilevel circuit switching network introduced by Charles Clos in 1953. Initially, this network was devised to increase the capacity of crossbar switches. It became less relevant due to the development and adoption of Very Large Scale Integration (VLSI) techniques. The use of complex optical interconnect topologies initially for high-performance computing (HPC) and later for cloud data centers makes this architecture relevant again. The Folded-Clos network topology utilizes two types of switch nodes, Spine, and Leaf. Each Spine is connected to each Leaf. The network can scale horizontally to enable communication between a large number of servers, while minimizing the latency and non-uniformity by simply adding more Spine and Leaf switches.

FCN depends on k, the switch radix, i.e., the ratio of Leaf switch server downlink compared to Spine switch uplink, and m, the number of tiers or layers of the network. The selection of (k,m) has a significant impact on the number of switches, the reliability and latency of the network, and the cost of deployment of the data center network. FIG. 1 shows the relationship between the number of servers for different levels of oversubscription, assuming all switches have similar radix and total oversubscription 1:1.

FIGS. 2A and 2B shows an example of two FCNs with a similar number of hosts, using different radixes and levels. The higher radix, 32 in this example, connects 32 edge switches in a two-layer network, as shown in FIG. 2A. The two-level FCN provides the lowest latency at the cost of requiring a denser network (512 interconnections). By using a three-layer network, the interconnection layout simplifies (256 interconnections). However, more switches are needed, and more latency is introduced in the network. During the last years, the need for flatter networks to address the growing traffic among machines has favored the radix increase of the switches' application-specific integrated circuits (ASICs). Currently, ASICs can handle 256 radix switches at a speed of 100 Gb/s per port. Those switches support 64×400 GbE, 128×200 GbE, or 256×100 GbE enabling flatter networks with at most three layers.

Based on industry telecommunications infrastructure Standard TIA-942-A, the locations of leaf and spine switches can be separated by tens or hundreds of meters. Typically, Spine switches are located in the main distribution area (MDA), whereas Leaf switches are located in the equipment distribution area (EDA) or horizontal distribution area (HDA).

This architecture has been proven to deliver high-bandwidth and low latency (only two hops to reach the destination), providing low oversubscription connectivity. However, for large numbers of switches, the Spine-Leaf architecture requires a complex mesh with large numbers of fibers and connectors, which increases the cost and complexity of the installation.

Future data centers will require more flexible and adaptable networks than the traditional mesh currently implemented to accommodate highly distributed computing, machine learning (ML) training loads, high levels of virtualization, and data replication.

The deployment of new data centers or scaling of data center networks with several hundred or thousands of servers is not an easy task. A large number of interconnections from Spine to Leaf switches is needed, as shown in FIG. 3. In this example, a fabric 100 can have 572 paths. Each line in the inset 120 can represent a group of eight or 12 fibers that are terminated in multi-fiber MPO connectors. The fibers can be ribbonized in the traditional flat or rollable ribbons. The inset 110 shows a zoom-in on a small area of the fabric 100.

The interconnecting fabric similar to or larger than 100s can be prone to errors which can be accentuated in many cases by challenging deployment deadlines or the lack of training of installers. Although the Spine-Leaf topology is resilient to misplaced connections, a large number of interconnection errors will produce a noticeable impact due to performance degradation resulting in the loss of some server links. Managing large-scale network configurations usually requires a dedicated crew to check the interconnections, which causes delays and increases the cost of the deployment.

Using transpose boxes, as shown in the prior art, can help to reduce installation errors. However, the prior art cannot be easily adapted to different network topologies, switches radixes, or oversubscription levels.

A new mesh method and apparatus that utilizes modular flexible, and better-organized interconnection mapping that can be quickly and reliably deployed in the data center is disclosed here.

In U.S. Pat. No. 8,621,111, US 2012/0250679 A1, and US 2014/0025843 A1, a method of providing scalability in a data transmission network using a transpose box was disclosed. This box can connect the first tier and second tier of a network. This box facilitates the deployment of the network. However, a dedicated box for a selected network is required. As described in that application, the network topology dictates the type of transpose box to be used. Changes in the topology can require swapping the transpose boxes. Based on the description, a different box will be needed if the number of Spine or Leaf switches changes, the oversubscription, or other parameters of the network change.

Once the topology is selected, the application provides a method for scaling. This requires connecting the port of one box to another with a cable. This adds losses to the network and cannot efficiently accommodate the scaling of the network.

This approach disclosed in US 2014/0025843 A1, can work well for a large data center that has already selected the type of network architecture to be implemented and can prepare and maintain stock of different kinds of transpose boxes for its needs. A more flexible or modular approach is needed for a broader deployment of mesh networks in data centers.

In W2019099771A1, an interconnection box is disclosed. This application shows exemplary wiring to connect individual Spine and Leaf switches using a rack-mountable 1 RU module. The ports of these modules are connected internally using internal multi-fiber cables that have a specific mesh incorporated. However, the module appears to be tuned to a particular topology, such as providing mesh among four spine and leaf switch ports. The application does not describe how the device can be used for topologies with a variable number of leaf or spine switches or with a variable number of ports.

In US20150295655A, an optical interconnection assembly that uses a plurality of leaf-side multiplexers and demultiplexers at each side of the network, one on the Spine side and another set near the Leaf is described. Each mux and demux is configured to work together in the desired topology. However, the application does not demonstrate the flexibility and scalability of this approach.

U.S. Ser. No. 11/269,152 describes a method to circumvent the limitations of optical shuffle boxes, which according to the application, do not easily accommodate for reconfiguration or expansion of switch networks. The application describes apparatuses and methods for patching the network links using multiple distribution frames. At least two chassis are needed to connect switches from one to another layer of a network. Each chassis can accommodate a multiplicity of modules, e.g., cassettes arranged in a vertical configuration. The connection from a first-tier switch to one side of the modules is made using breakout cables. One side of the breakout cables is terminated in MPO (24 fibers) and the other in LC or other duplex connectors. One side of the modules has one or two MPO ports, and the other six duplex LC connectors or newer very-small form factor (VSFF) connectors.

Similarly, the second-tier switch is connected to modules in the other chassis. The patching needed to connect the switches is performed using a plurality of jumper assemblies configured to connect to the plurality of optical modules. The jumpers are specially designed to fix their relative positions since they must maintain the correct (linear) order. U.S. Ser. No. 11/269,152 describes a method for patching, and it can make networks more scalable depending on the network radix. However, the network deployment is still challenging and susceptible to interconnection errors.

### SUMMARY

An apparatus having a plurality of multifiber connector interfaces, where some of these multifiber connector interfaces can connect to network equipment in a network using multifiber cables, has an internal mesh implemented in two tiers. The first is configured to rearrange and the second is configured to recombine individual fiber of the different fiber groups. The light path of each transmitter and receiver is matched in order to provide proper optical connections from transmitting to receiving fibers and complex arbitrary network topologies can be implemented with at least 1/N less point to point interconnections, where N=number of channels per multifiber connector interface. Also, the fiber interconnection inside the apparatus can transmit signal at any wavelength utilized by transceivers, e.g., 850 nm-1600 nm. Due to the transparency of the fiber interconnection in the apparatus, the signals per wavelength can be assigned to propagate in one direction from transmitter to receiver or in a bidirectional way.

### BRIEF DESCRIPTION OF THE DRAWINGS

FIG. 1 shows the number of servers as a function of switch radix and the number of switch layers of the network.

FIG. 2A shows an example of an FCN with a similar number of hosts, using different radixes and levels of that in FIG. 2B.

FIG. 2B shows a second example of an FCN with a similar number of hosts, using different radixes and levels of that in FIG. 2A.

FIG. 3 shows interconnections of an example mesh that contains 576 interconnects (each with 12 or 8 fibers).

FIG. 4A shows a front view of the disclosed module 400.

FIG. 4B shows the rear view of module 400.

FIG. 5 shows a top view of module 400.

FIG. 6 shows the interconnections of module 400.

FIG. 7 shows the interconnection of region 480 of module 400.

FIG. 8 is a top view of submodule 500 showing interconnection arrangements.

FIG. 9 shows 16 possible configurations that can be implemented in a submodule.

FIG. 10A Illustrates a simple method for implementing networks with 16 Leaf Switches and up to 16 Spine switches, using the modules 400.

FIG. 10B further illustrates a simple method for implementing networks with 16 Leaf Switches and up to 16 Spine switches, using the modules 400.

FIG. 10C further illustrates a simple method for implementing networks with 16 Leaf Switches and up to 16 Spine switches, using the modules 400.

FIG. 10D further illustrates a simple method for implementing networks with 16 Leaf Switches and up to 16 Spine switches, using the modules 400.

FIG. 11A shows an example of interconnections between Spine port and Modules 400.

FIG. 11B shows an interconnection table for the example of FIG. 11A.

FIG. 12A shows an example of interconnections between ports of modules 400 and Spine chassis ports eight spines with two linecards each when combined with FIG. 12D.

FIG. 12B shows an example of interconnections between ports of modules 400 and Spine chassis ports eight spines with four spines with four linecards each when combined with FIG. 12E.

FIG. 12C shows an example of interconnections between ports of modules 400 and Spine chassis ports eight spines with two Spines with eight linecards each when combined with FIG. 12F.

FIG. 12D shows an example of interconnections between ports of modules 400 and Spine chassis ports eight spines with two linecards each when combined with FIG. 12A.

FIG. 12E shows an example of interconnections between ports of modules 400 and Spine chassis ports eight spines with two linecards each when combined with FIG. 12B.

FIG. 12F shows an example of interconnections between ports of modules 400 and Spine chassis ports eight spines with two linecards each when combined with FIG. 12C.

FIG. 13 illustrates the method for implementing two-tier FCN.

FIG. 14 illustrates the method for implementing two-tier FCN.

FIG. 15 illustrates the method for implementing two-tier FCN.

FIG. 16 illustrates the method for implementing two-tier FCN.

FIG. 17 illustrates the method for implementing two-tier FCN.

FIG. 18 illustrates the method for implementing three-tier FCN.

FIG. 19 illustrates the method for implementing three-tier FCN.

FIG. 20 illustrates deployment of a 3-tier FCN with 32 PODs and 16 switches per POD using a stack of modules 400. The figure shows the front side of the stack. L (Leaf abbreviation) and p (POD) represent the Leaf switch and POD number, respectively.

FIG. 21 illustrates deployment of a 3-tier FCN with 32 PODs and 16 switches per POD using a stack of modules 400. The figure shows the back side of the stack. S (Spine abbreviation) and c (linecard) represent the Spine switch and linecard number, respectively.

FIG. 22 shows Table I, a mesh configuration table of sixteen possible arrangements, 610 to 640 of submodule 500.

FIG. 23 shows Table II, a mesh configuration of module 400.

FIG. 24 shows Table III, displaying parameters for a two-layer FCN with oversubscription 3:1 with 16 Spine switches.

FIG. 25 shows Table IV, displaying parameters for a two-layer FCN with oversubscription 1:1 for 32 Spine switches.

FIG. 26 shows Table V, displaying parameters for three-layer FCNs with oversubscription 1:3 for 256 Spine switches (16 Chassis with 16 linecards).

FIG. 27 shows Table VI, displaying parameters for three-layer FCNs with oversubscription 1:1 for 1024 Spine switches (64 chassis with 16 linecards).

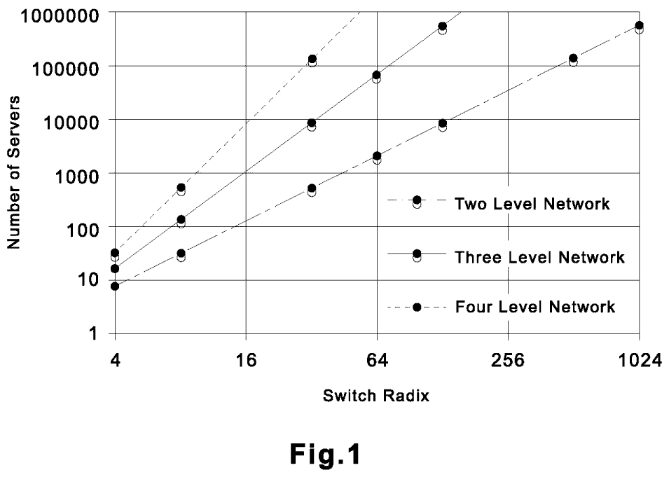

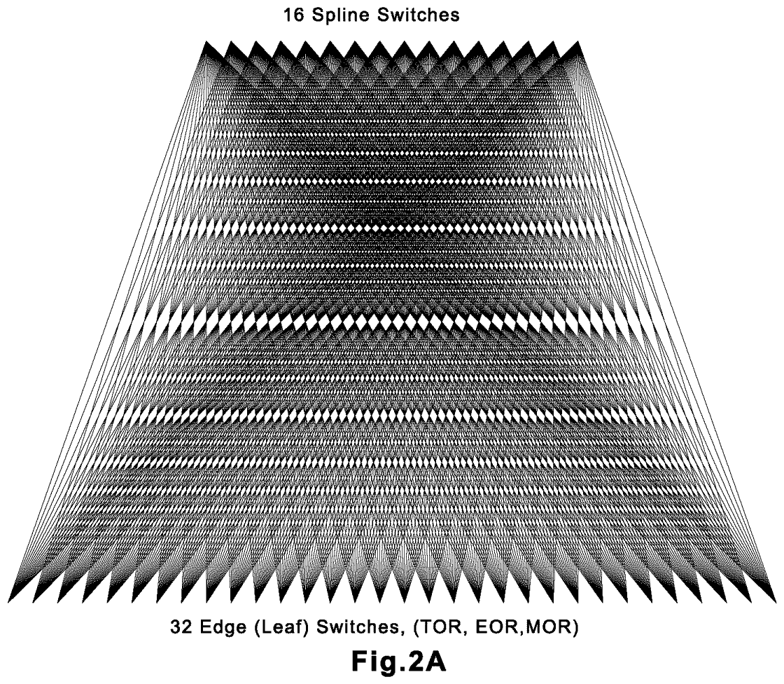

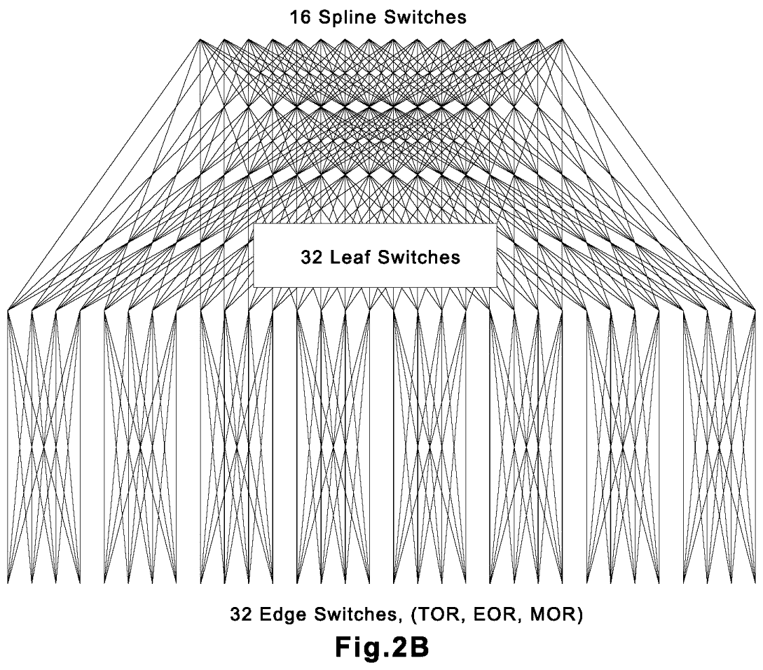

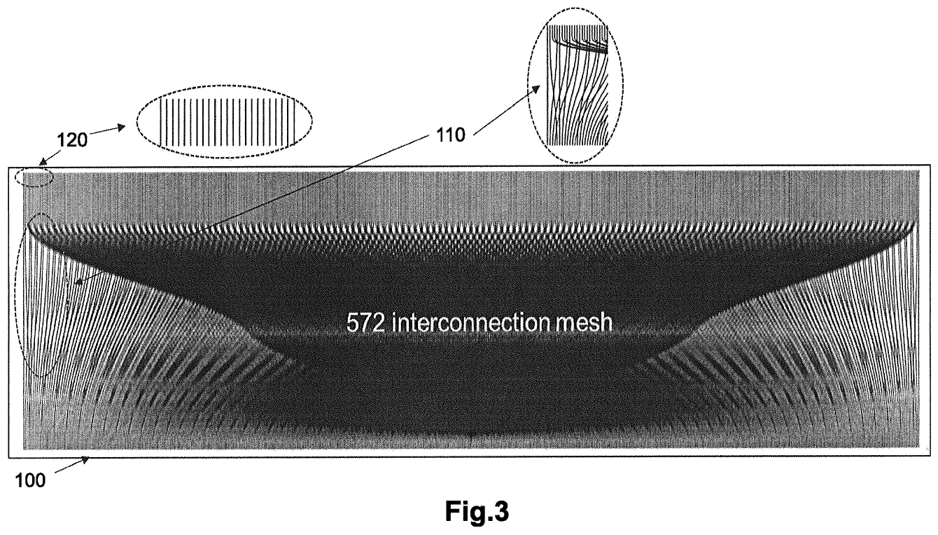

### DESCRIPTION OF INVENTION

A modular apparatus and general method to deploy optical networks of a diversity of tiers and radixes are disclosed in this document. The module and method can be used with standalone, stacked, or chassis network switches, as long as the modular connections utilize MPO connectors with eight or more fibers. In particular, switches with Ethernet specified SR or DR transceivers in their ports, such as 40 GBASE-SR4, 100 GBASE-SR4, 200 GBASE-SR4, or 400 GBASE-DR4, can use these modules without any change in connectivity. Network with single-lane duplex transceivers (10G SR/LR, 25G SR/LR), 100 GBASE-LR4, 400 GBASE-LR4/FR4) will also work with these mesh modules, provided that correct TX/RX polarity is maintained in the mesh. Other types of transceivers, such as 400 GBASE-FR4/LR4, can also be used by combining four transceiver ports with a harness or a breakout cassette.

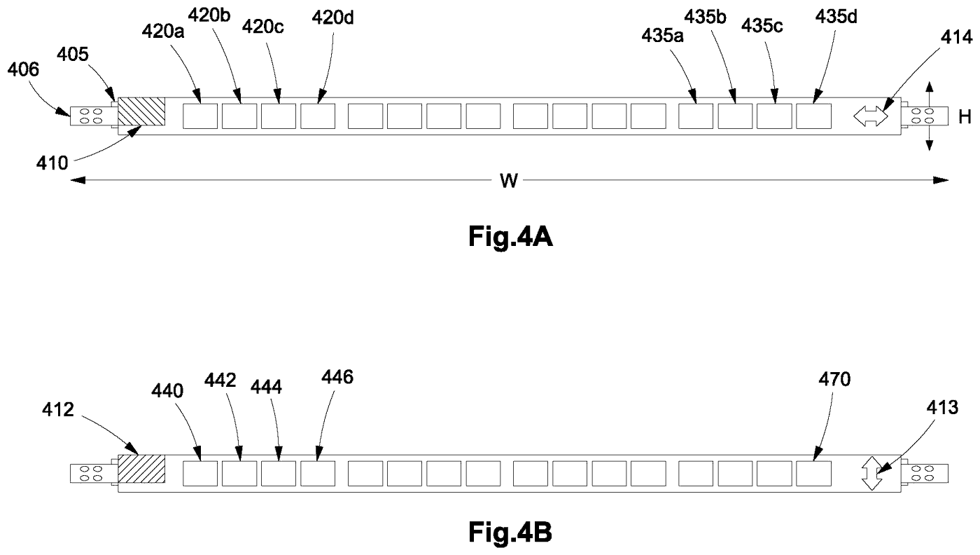

FIG. 4A shows a front view of the disclosed module 400, which is the key element in facilitating optical network deployment, reshaping, and scaling. In this embodiment, the module has 32 MPO connector ports that can be divided into the front and rear sections, as shown in FIGS. 4A and 4B. Alternatively, the 32 ports could be located on one face of the device (not shown here).

For the sake of illustration, we assume that ports 420 to 435, each with four MPO connectors, labeled a,b,c, and d, are located on the front side of the module, facing the Leaf switches, as shown in FIG. 4A. On the other side of the module, ports 440 to 470 (opposite to the 420-435 ports), each representing one MPO connector, face the Spine switches connections. The MPO dimensions allow a module width, W, in the range of 12 inches up to 19 inches, and the height, H, is in the range of 0.4 to 0.64 inches. The small width of the 16 MPO connectors relative to rack width (19 inches) provides enough space to place machine-readable labels, 410, 412, and visual labels 414, 413, that can help deploy or check the network interconnection as described later in this application. Also, lateral rails, 405, on both sides of the module, would enable the modules to be inserted into a chassis structure if required. Alternatively, using brackets 406, the modules can be directly attached to the rack. By using the specified height range for this embodiment, up to four modules can be stacked in 1 RU or less than 1.5 RU depending on density requirements.

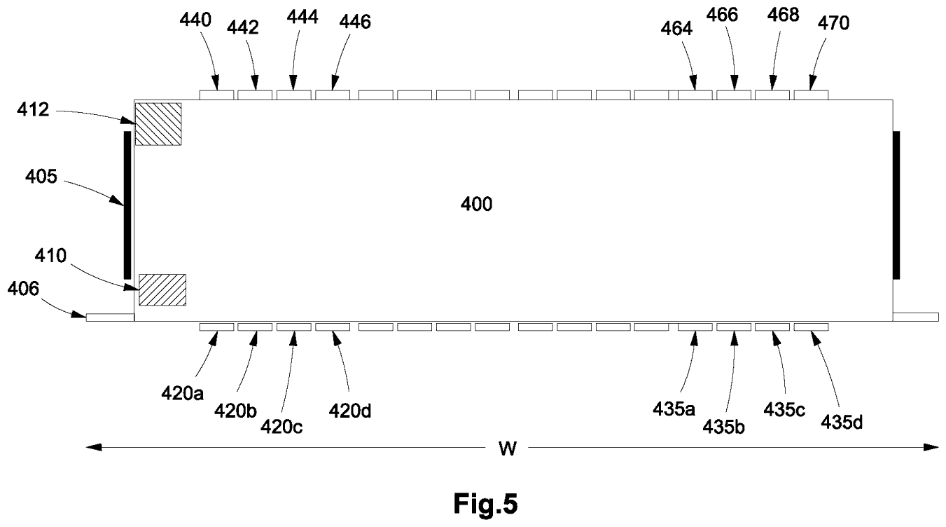

FIG. 5 shows a top view of the module, showing additional machine-readable labels 410 and 412. A laser scanner or a camera can read the labels. The read code can link to a database that has the interconnection maps of all modules in the network. The information can be displayed on a portable device, tablet, phone, or augmented reality lens to facilitate the deployment.

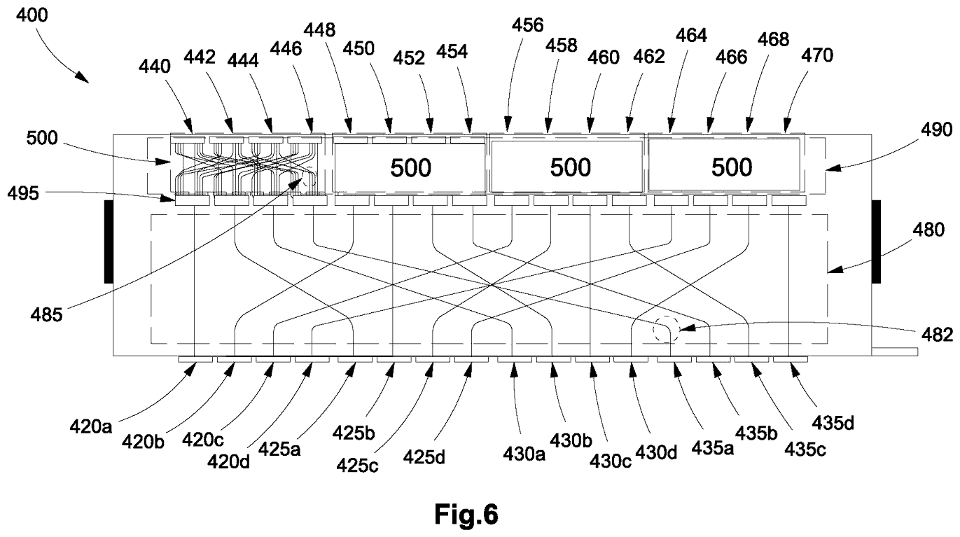

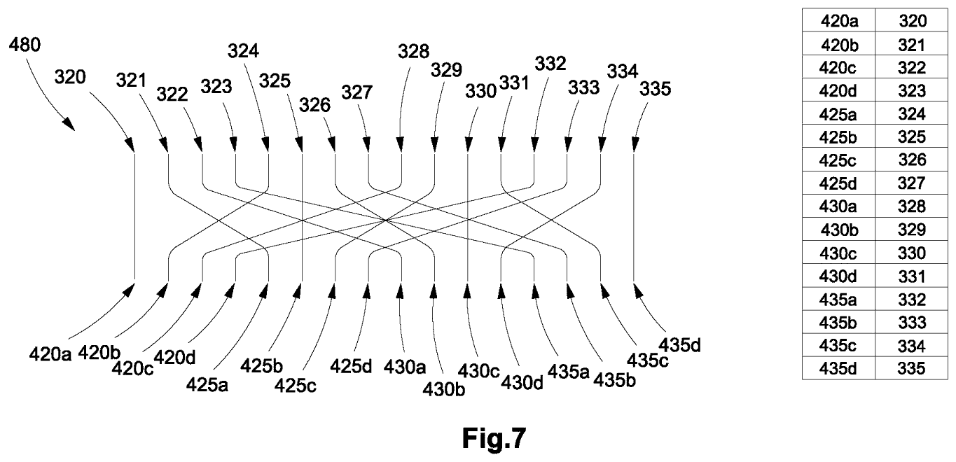

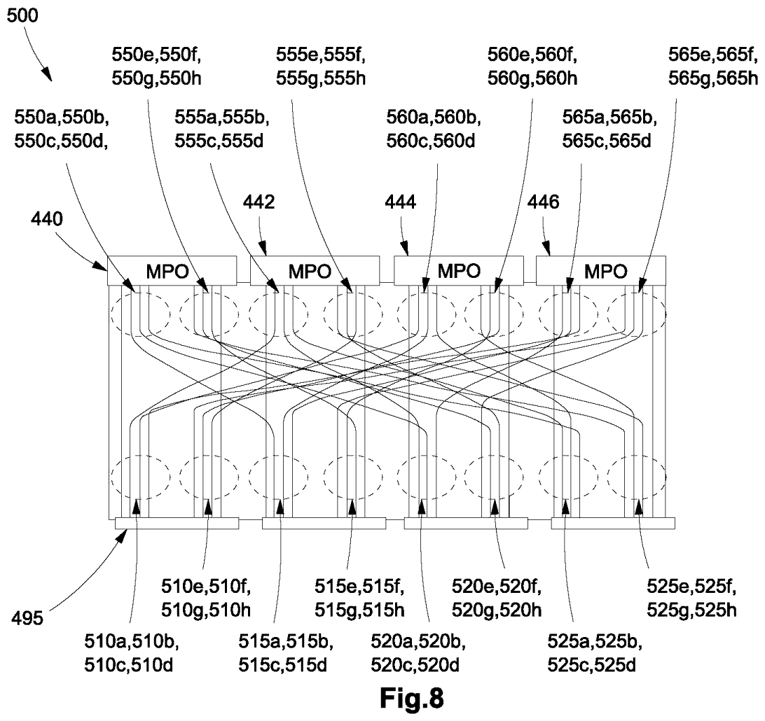

FIG. 6 shows the interconnection scheme of the modules according to the present invention. The interconnection configuration of all module ports is described in Tables I and II. To simplify the module structure, the mesh is divided into two regions, 480 and 490. Region 480 re-orders groups of fibers, e.g., 482 is paired with 485, which can be standard or rollable ribbons or just cable units of 8, 12, or 16 fibers. The connection method needed to simplify the connection of Leaf switches is described in FIG. 7. In region 490, the mesh is implemented at the fiber level. For example, fibers 485 from the group of fibers 420a and fibers 482 from group 435a, mix with fibers from two other groups 425a and 430a. In this embodiment, four submodules, 500, are used to produce the interconnection mesh of the four groups of fibers shown in this embodiment. FIG. 8 shows a connection diagram for one of the submodules 500. In this figure, we show how the fibers in ports groups 510 to 525 are mixed with the other fibers from groups 515 and 520 coming from submodule 480. On the opposite side, depending on the position of the submodule 500, its outputs 550-565 can correspond to four module ports, e.g., 440-446. Hence, an apparatus, according to the present invention, mixes the Ethernet physical media dependent (PMD) lanes with other transceiver PMD lanes in order to distribute the network data flow and help balance the data flow load to any one transceiver.

For an MPO transmitting four parallel channels, the mesh of submodule 500 can be implemented in a large permutation of arrangements. For a MPO connector with Nf=12 fibers, Nc=4 duplex channels, and Np=4 multifiber connector ports, the topological mapping from Inputs ports, I_{A}, and I_{B} to outputs ports O_{A} and O_{B} described in the equations below preserve the correct paths from the transmitter to receivers.

Input ports: I_{A}=i+Nf×(k−1),I_{B}=1−i+Nf×k, (1)

Outputs ports: O_{A}=p(i,r₁)+Nf×(p(k,r₂)−1),O_{B}=1−p(i,r₁)+Nf×p(k,r₂), (2)

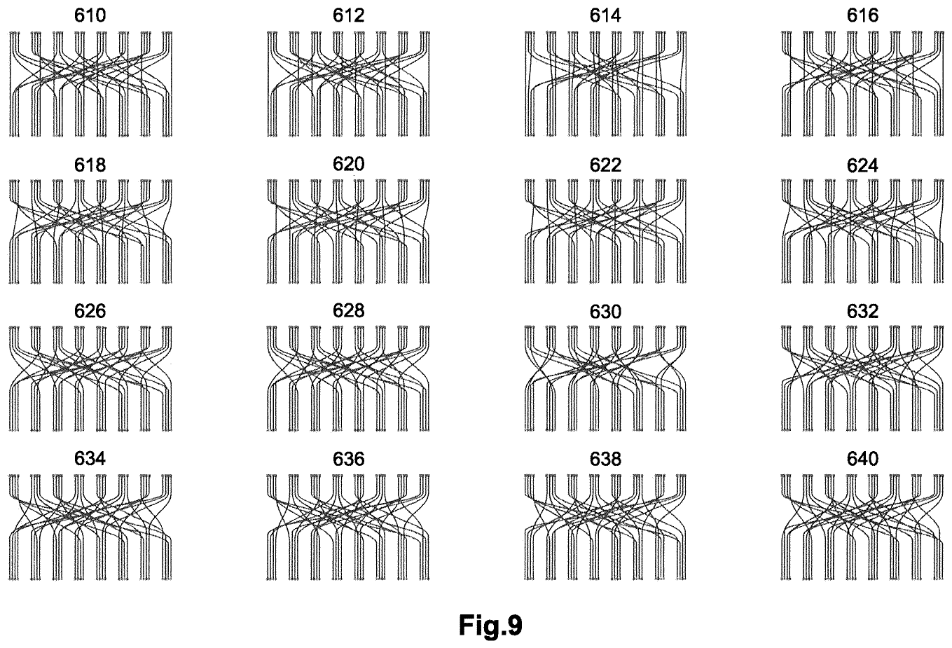

In (1) and (2), i is an index ranging from 1 to Nc, which relates to the input duplex ports of the connector, k is an index of the connector, ranging from 1 to Np and p(.,.) is a permutation function which has two input parameters, the first one is the number to be permutated, and the second the permutation order in a list of Nc!=24 possible permutations. These sets of equations indicate that r1 and r2 determine the number of possible configurations; therefore, module 500 can have r1×r2=576 connecting I_{A} to O_{A} and I_{B} to O_{B}, and in total, 1152 possible configurations when crossing connections are used, e.g., I_{A} to O_{B}. Sixteen configurations are shown in FIG. 9. And their interconnection arrangements are described in Table I enabling efficient use of connectivity methods, e.g., TIA 568.3 D Method A or Method B.

The two-step mesh incorporated in each module 400, by combining sections 480 and 490, increases the degree of mixing of the fiber channels inside each module. This simplifies the deployment of the network since a significant part of the network complexity is moved from the structured cabling fabric to one or more modules 400. The fibers of the regions 480 and 490 are brought together by 495, which represents a connector or a splice. Note that at this joint point, the fiber arrays from region 480 can be flipped to accommodate for different interconnection methods, e.g., TIA 568.3 D Method A or Method B. Using module 400 and following simple rules to connect a group of uplinks or downlinks horizontally or vertically the installation becomes cleaner, and cable management is highly improved as it will be shown in the following description of this application.

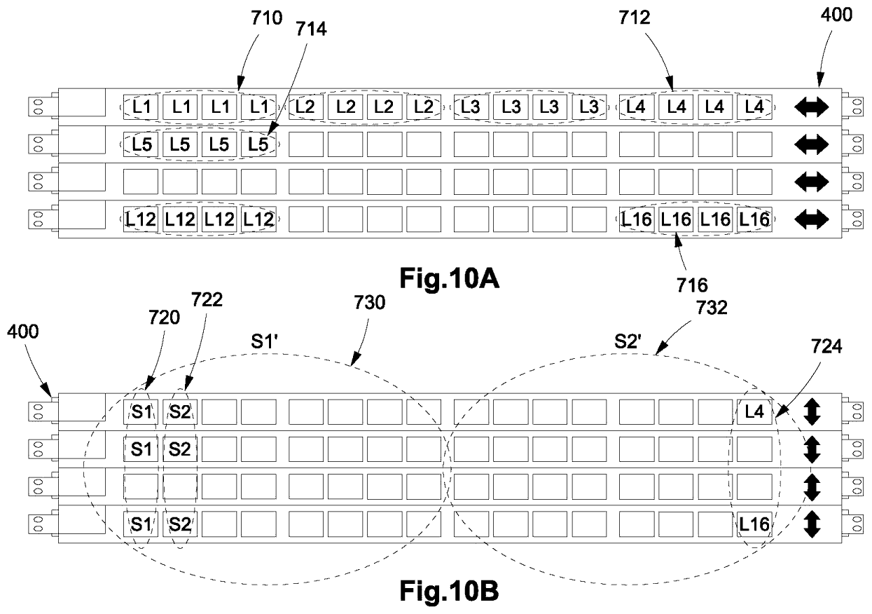

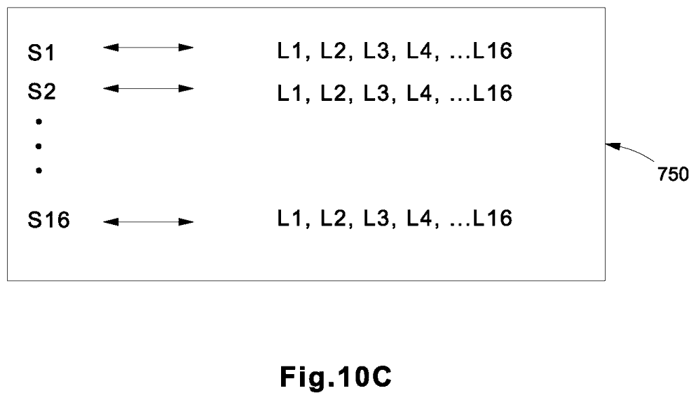

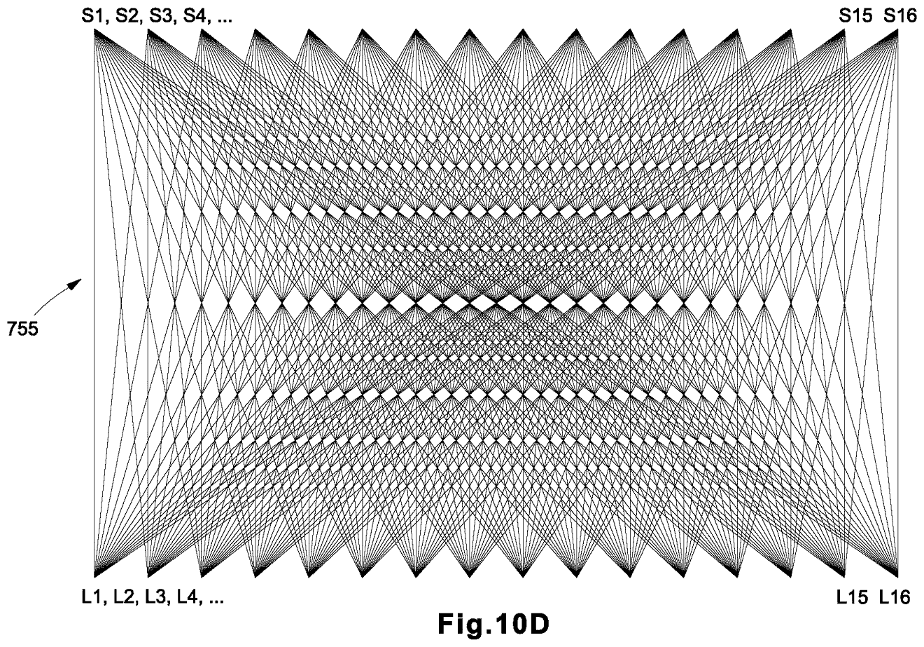

A group of N modules 400 can enable diverse configuration of radixes, with various numbers of Spine and Leaf switches. For example, FIGS. 10A-10D show a stack of four modules 400. FIG. 10A shows the module side that is connected to the Leaf switches. For simplicity, we label this as the front side. FIG. 10B shows the opposite side of the same module 400, the backside, which is connected to the Spine switches.

The diagrams in FIGS. 10A-10D assume that sixteen Leaf switches, each with four MPO uplinks, need to be connected to the fabric shown in FIG. 10D. In this illustrative example, the uplinks of the Leaf switches are connected horizontally in groups of four until the last port of each module 400 is used. For example, 710 and 712, the first and the last fourth ports of the first module 400 connect to the uplink ports of the Leaf switches L1 and L4, respectively. The uplinks of the fifth Leaf switch populate ports 714 of the second module 400. This method continues until the uplinks of the last Leaf switch are connected to the ports 716.

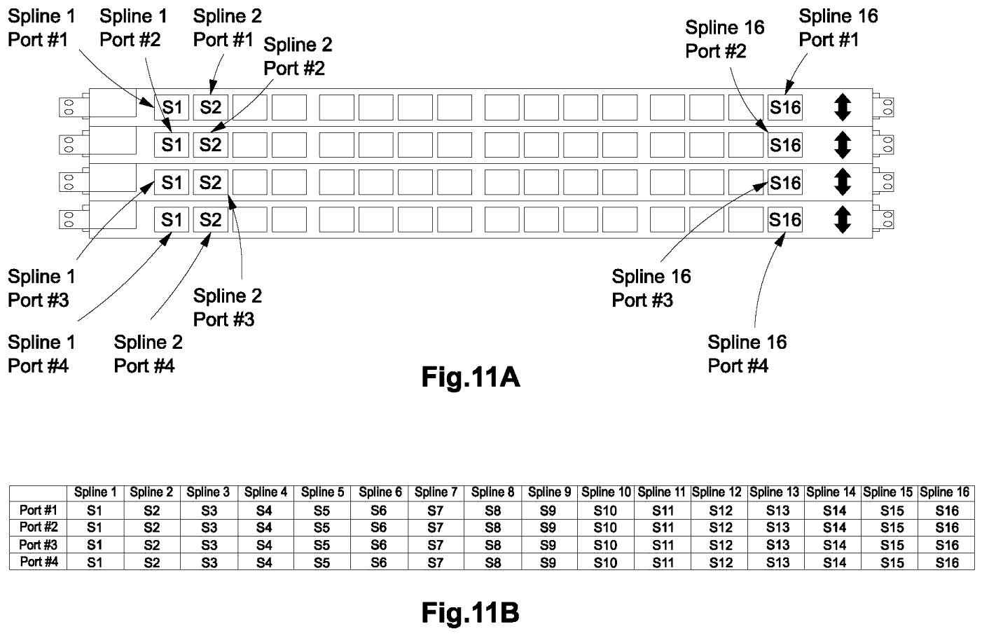

The Spines ports are assigned at the backside of the stacked modules 400. For example, if standalone Spine switches are used, 720, 722, and 724 correspond to ports of the first, second, and sixteenth Spine switch, respectively, labeled as S1, S2, and S16 in FIGS. 10A-10D. A more detailed description of the connections from the module to the Spines is shown in FIGS. 11A and 111B.

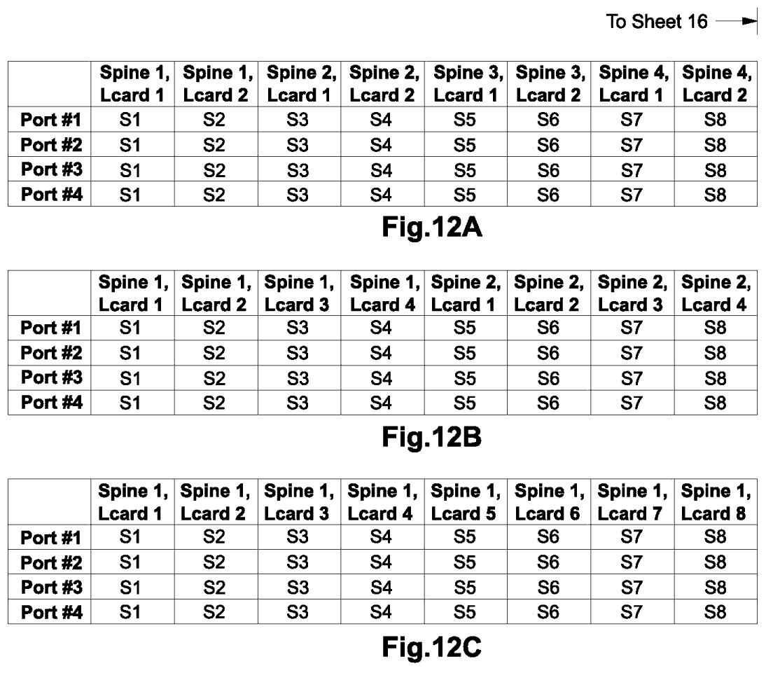

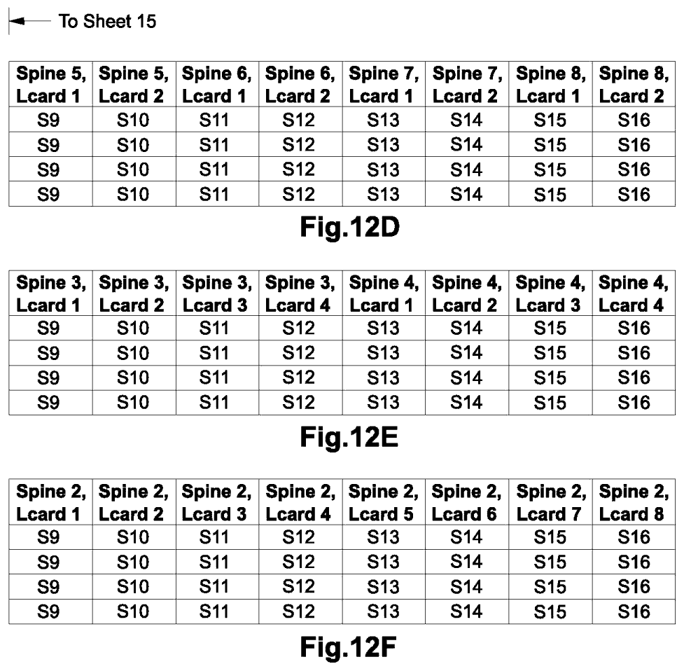

Alternatively, the Spines can be implemented using chassis switches. Although more expensive than standalone systems, chassis switches can provide several advantages such as scalability, reliability, and performance, among others. The port connectivity of the Spines using chassis switches can follow various arrangements. For example, using eight Spine switches, with two linecards each, all S1 and S2 ports can connect to the first Spine, S3 and S4 to the second Spine, and S15 and S16 ports to the last Spine. Using four Spine switches with four linecards each, all S1, S2, S3, and S4 ports can connect to the first Spine, S5, S6, S7, S8 to the second Spine, and S13, S14, S15, S16 to the last Spine. If only two Spine switches with eight linecards each are used, all the ports S1, S2, S3 to S8 will connect to the first Spine (S1′ in FIG. 9), and S9 to S16 ports will connect to the second Spine (S2′). A more detailed description of the connections from module to Spine is shown in FIGS. 12A-12F.

In many cases, e.g., when using chassis switches with many linecards, the number of Spine switches could be less than 16. In those cases, several ports can be grouped to populate the Spine switches. For example, 730 groups 32 ports to connect to a Spine S1′ and the other 32 ports labeled as 732 connect to a second spine (S2′). By using modules 400 and the described method, each Spine switch interconnects with all the Leaf switches as shown in equations in inset 750 of FIGS. 10A-10D. A representation of the mesh shown in 755, can be verified by following the connectivity tables from FIG. 7, Table I and II. In general, module 400 reduces the complexity of scaling up or scaling up or even de-scaling the network, as it is shown. The interconnection inside the apparatus can transmit signal at any wavelength from 830 nm-1650 nm. Moreover, the signals assigned to each wavelength can propagate in one direction from transmitter to receiver or in a bidirectional way.

### Examples of Network Deployment of Networks Using Modules 400

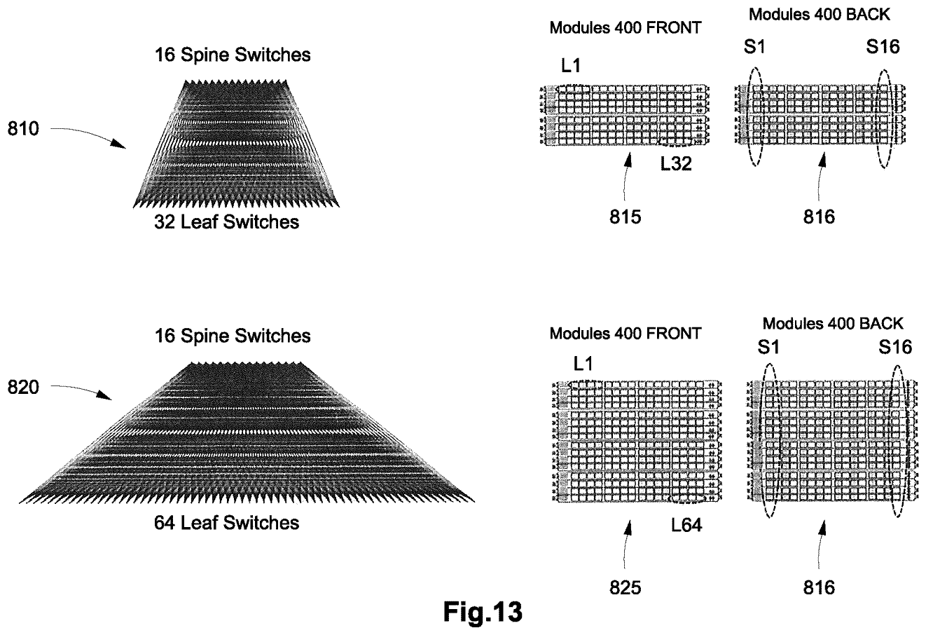

The examples in FIGS. 13 to 17 show the implementation of two-tier and three-tier FCNs of various radixes, oversubscription, and sizes using modules 400. A detailed description of the number of modules needed for each network and an estimation of the rack space required for the modules is shown in Tables III to VI.

Starting with two-tier FCNs, FIG. 13 shows two fabrics, 810 and 820, each with 16 Spine Switches. Fabric 810, shown in the figure, can be implemented using four modules 400. The connection map module 400 stack is shown from both sides of the module, one labeled front, 815, and the one labeled back, 817. The 815 side connects to 32 Leaf switches with four MPO uplinks with assigned eight fibers for duplex connections. The switches are labeled Li, where i is the index of the switch. For this example, i is in the range of 1 to 16. As shown in the figure on the 815 side, the Leaf switches connect horizontally. All L1 uplinks are connected adjacently in the first four ports of the first module 400. All L32 uplinks are connected to the last four ports of the eighth module 400. From the side 816, the backside of the same module stack, 16 Spine switches connect vertically, as shown in the figure. Based on the disclosed dimensions of module 400, this fabric can be implemented in less than 3 RU.

Fabric 820, which has 64 Leaf switches with four MPO uplinks, can be implemented using four modules 400. The connection method is similar to the one described above. From the 825 side, all Leave switches uplinks are connected adjacently following a consistent method. For example, L1 is connected to the first four ports of the first module 400. All L64 uplinks are connected to the last four ports of the sixteenth module 400. From the side 826, the backside of the same module stack, 16 Spine switches connect vertically, as shown in the figure. Based on the disclosed dimensions of module 400, this fabric can be implemented in less than 5 RU.

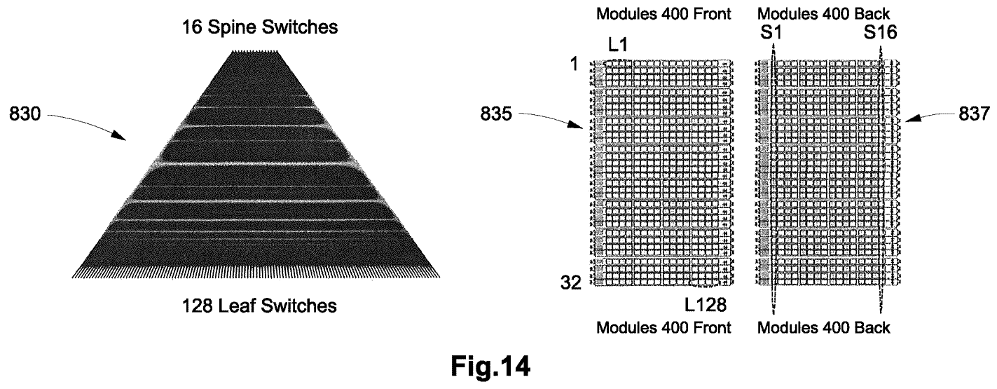

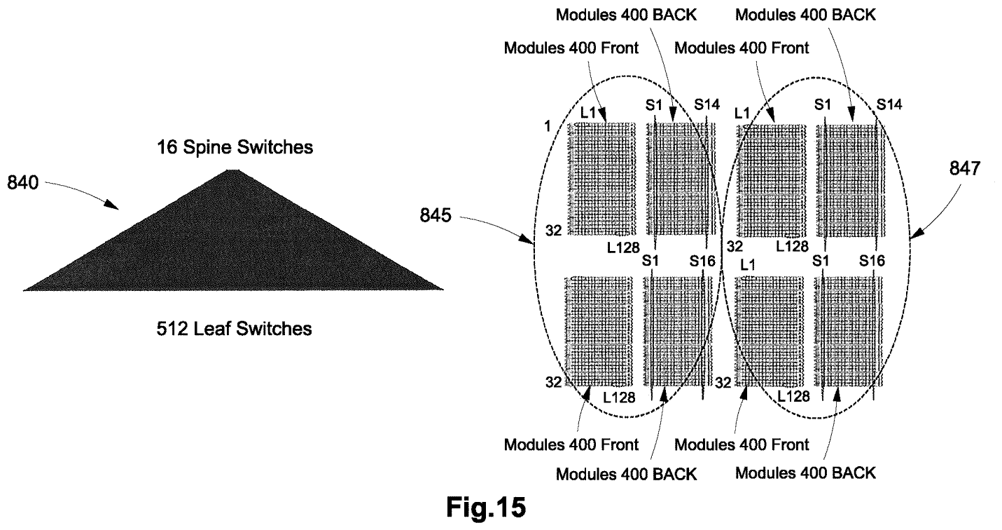

The networks in FIGS. 14 and 15 have the same number of spine switches but a much larger number of Leaf switches. The implementation procedure is similar. For 830, L1 is connected to the first four ports of the first module 400, and the L64 uplinks are connected to the last four ports of the thirty-second module 400. The Spine switches are connected vertically, as mentioned above. The network shown in 850 requires 128 modules, and due to the large number of ports, the Spines need to be implemented with chassis with 16 linecards.

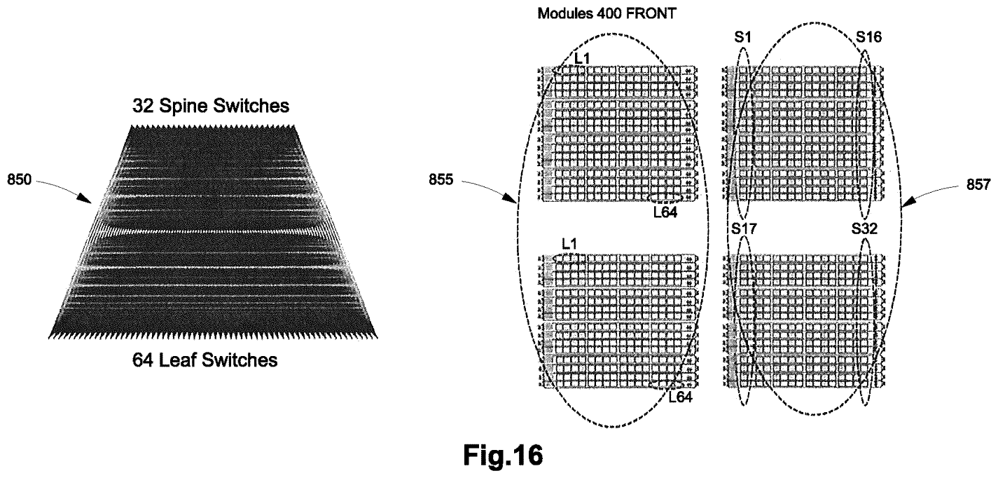

The fabrics described below have Leaf switches with radix 32, which means they have 16 uplinks (4 MPOs) and 16 downlinks (4 MPOs). FIG. 16 shows a network using Leaf Switches with radix 64, 8 MPOs for uplinks, and 8 MPOs for downlinks.

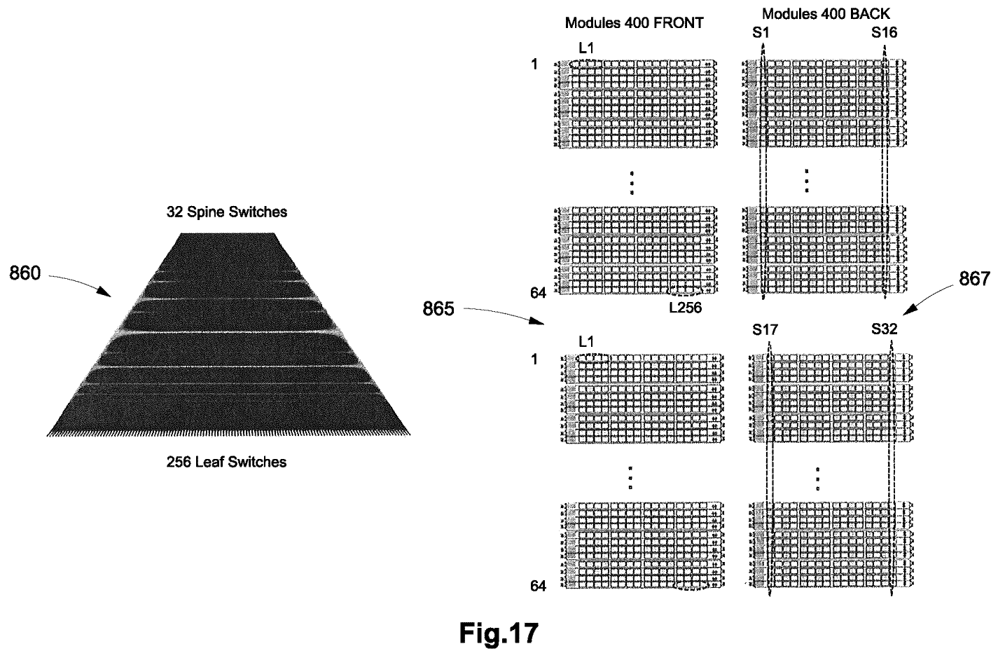

Implementing this network produces lower oversubscription ratios, e.g., 1:1, at the cost of more complexity. Modules 400 can also be used to simplify the installation. As shown in FIG. 16, 16 modules are used to connect to 64 Leaf switches. The uplinks of all the Leaf switches are divided into two groups of 4 MPO each. There is no need for any special order or procedure for this separation. Each group is installed exactly as shown in FIG. 13 for network 820. This means using 16 modules 400, the first group of 4 MPO uplinks per each Leaf mesh with the first 16 Spines (1S to 16S). The second group of uplinks connects to the spines S17 to S32, as shown in the figure. Using this method, the network can be scaled to a couple of thousand Leaf servers. FIG. 17 illustrates the implementation for a network with 256 Leaf switches.

As shown in Tables III and IV, using two-layer networks, the network can be scaled to support thousands of Leaf switches that can interconnect 10s of thousands of servers. A method to scale beyond that number requires using a three-layer FCN. FIG. 16 shows a topology of a three-layer network with 16 Spine and 32 Leaf switches. In a three-layer network, the Spines do not need to be connected to all Leaf switches but to a group of them called PODs.

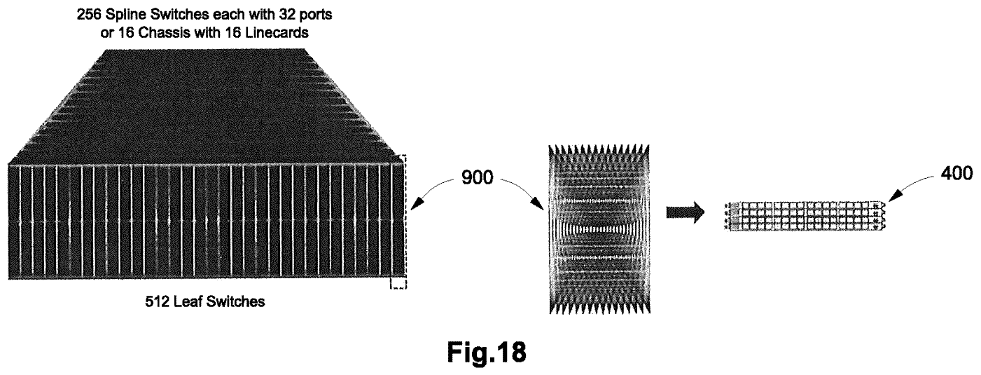

Module 400 can also be used to implement three-layer FCNs, as shown in FIGS. 18, 19, and 20. In FIG. 18, a three-layer network with 256 Spine and 512 Leaf switches is shown. Each POD of the network, 900, has sixteen Fabric and Leaf switches. Each POD's mesh can be fully implemented with four stacked modules 400, as it was shown previously (see FIG. 10D. Since there are 32 PODs, 900, 128 modules 400 are needed to implement the first section of this network (Fabric Switch to Leaf Switch).

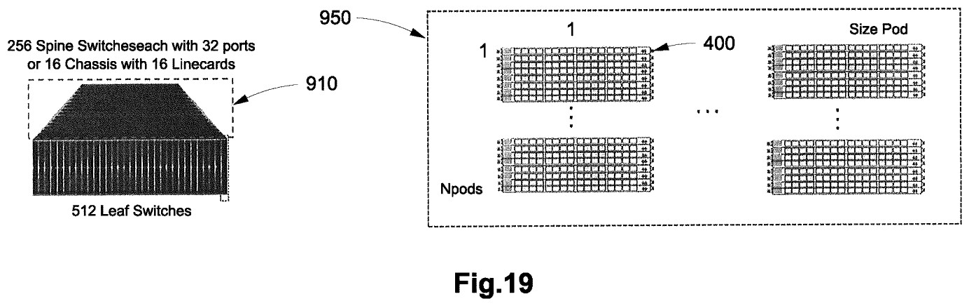

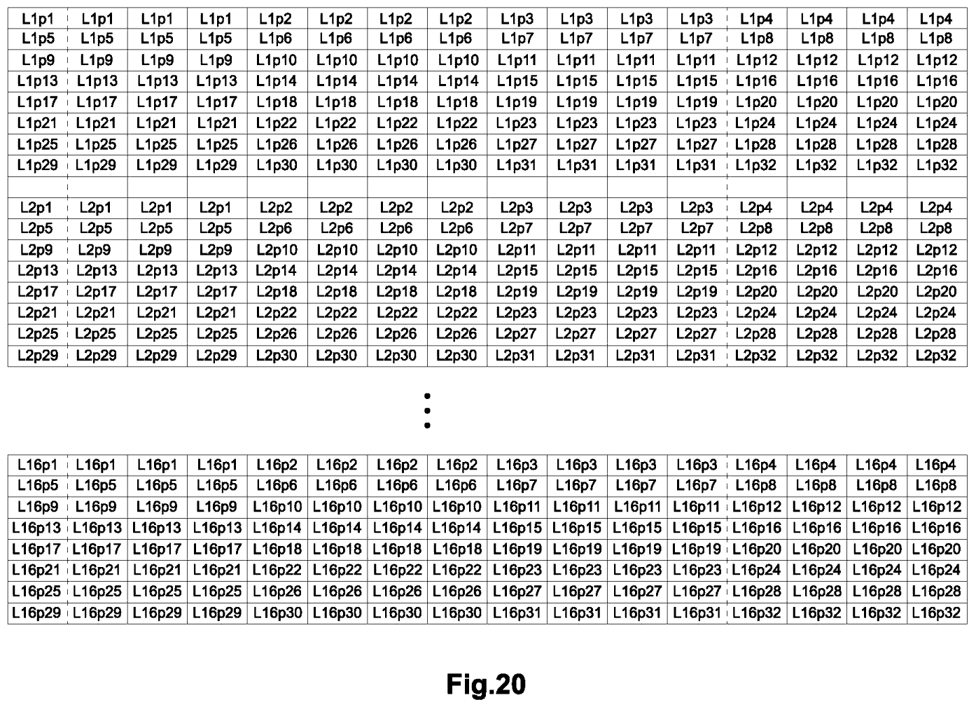

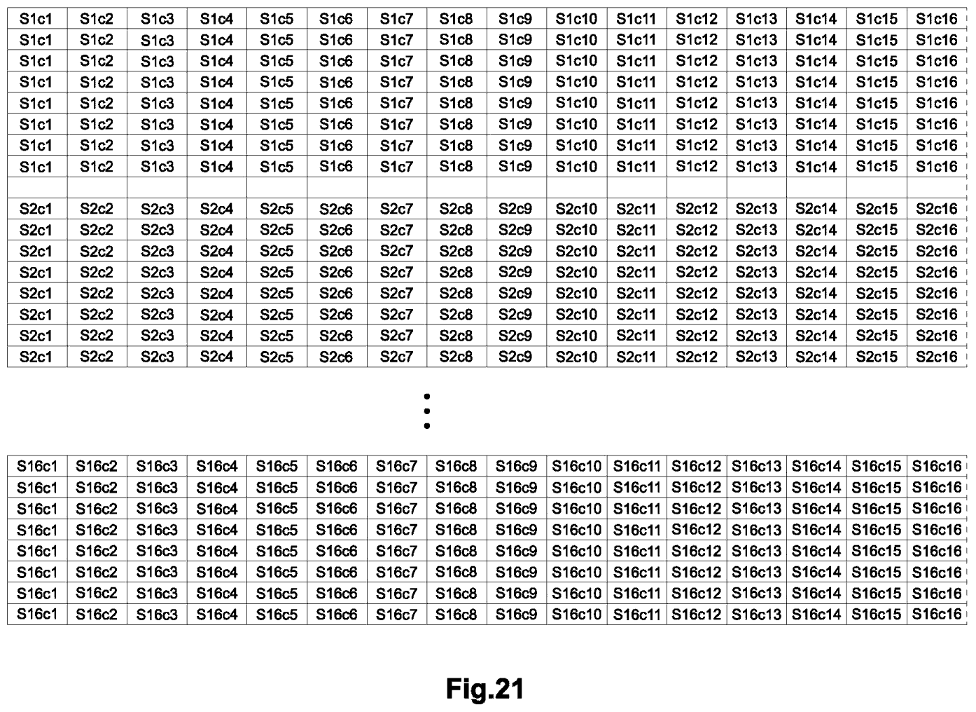

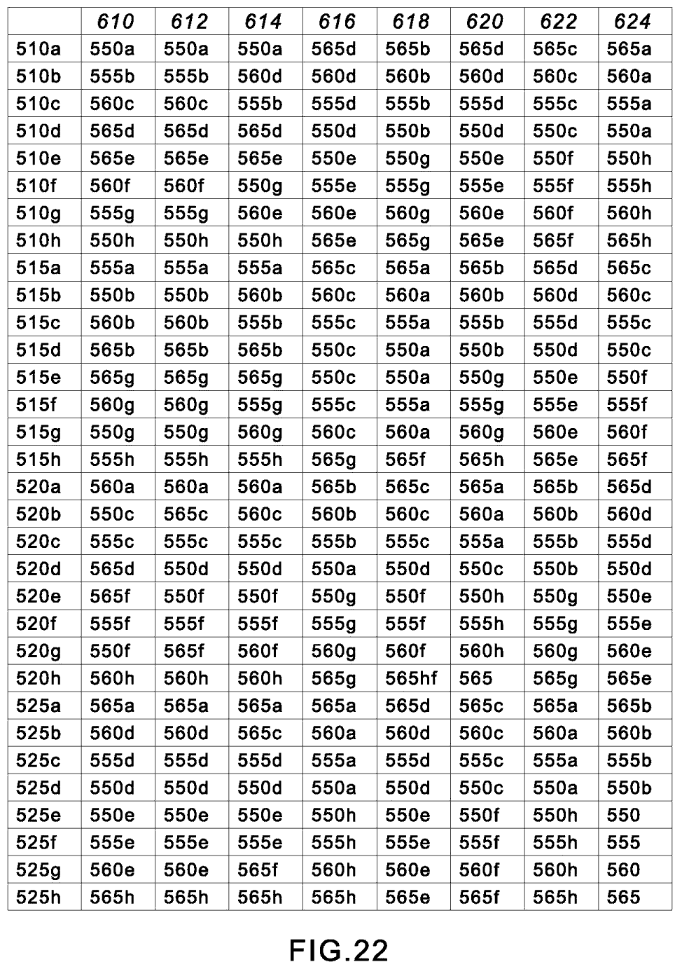

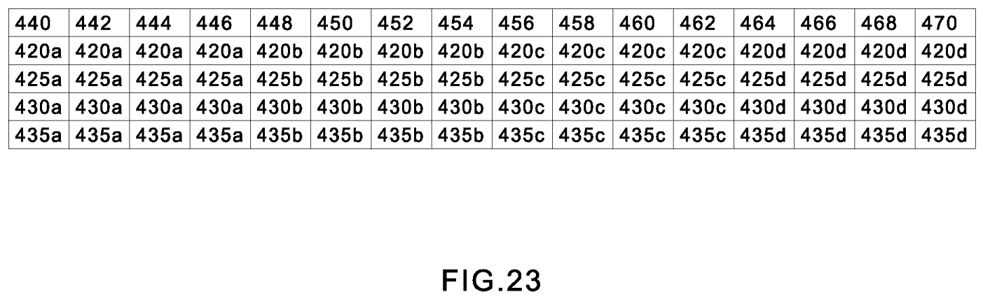

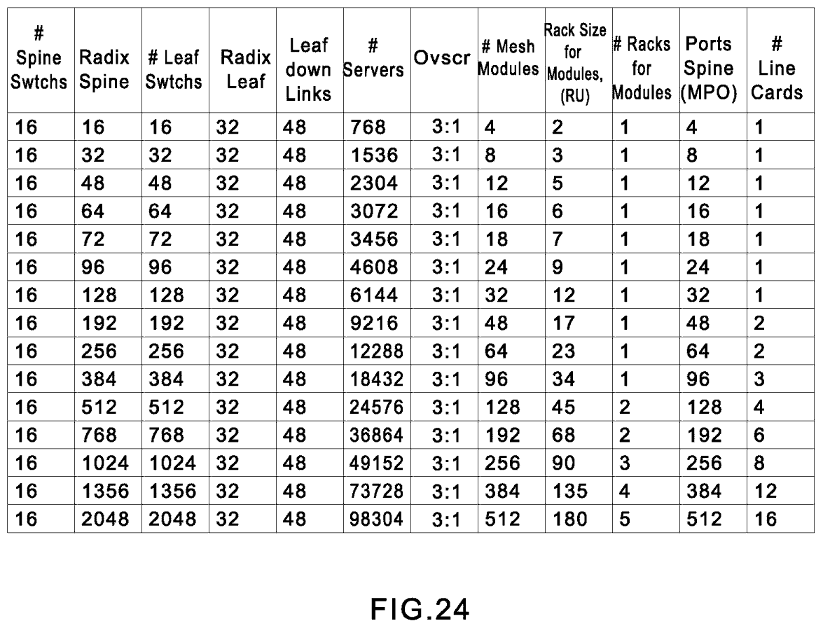

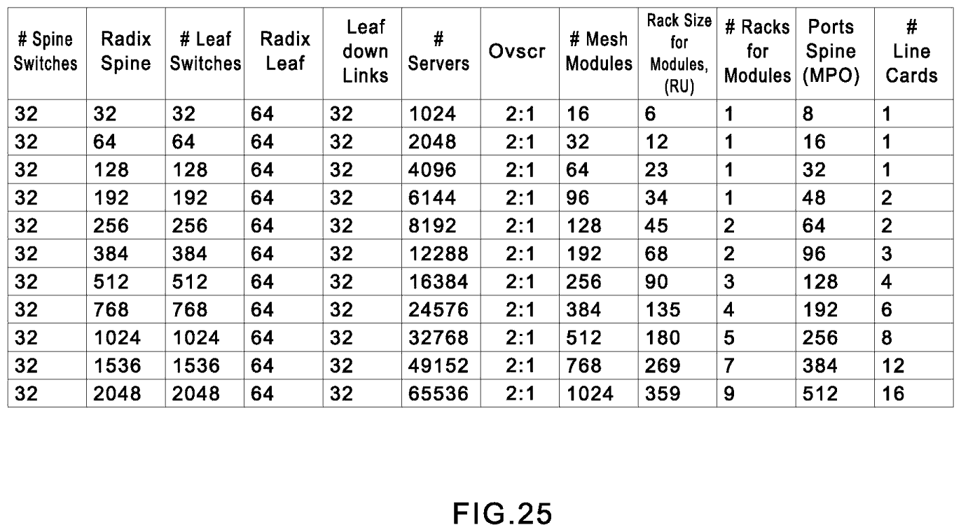

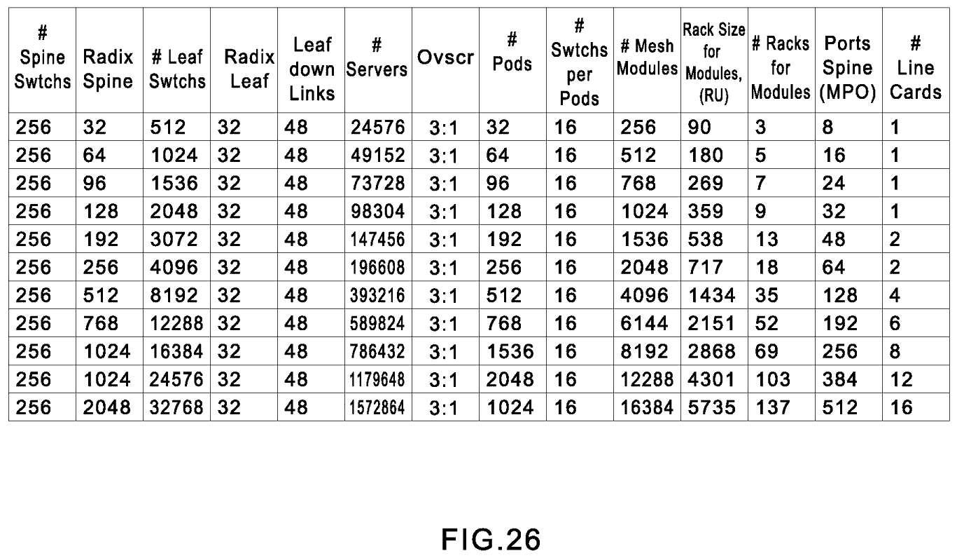

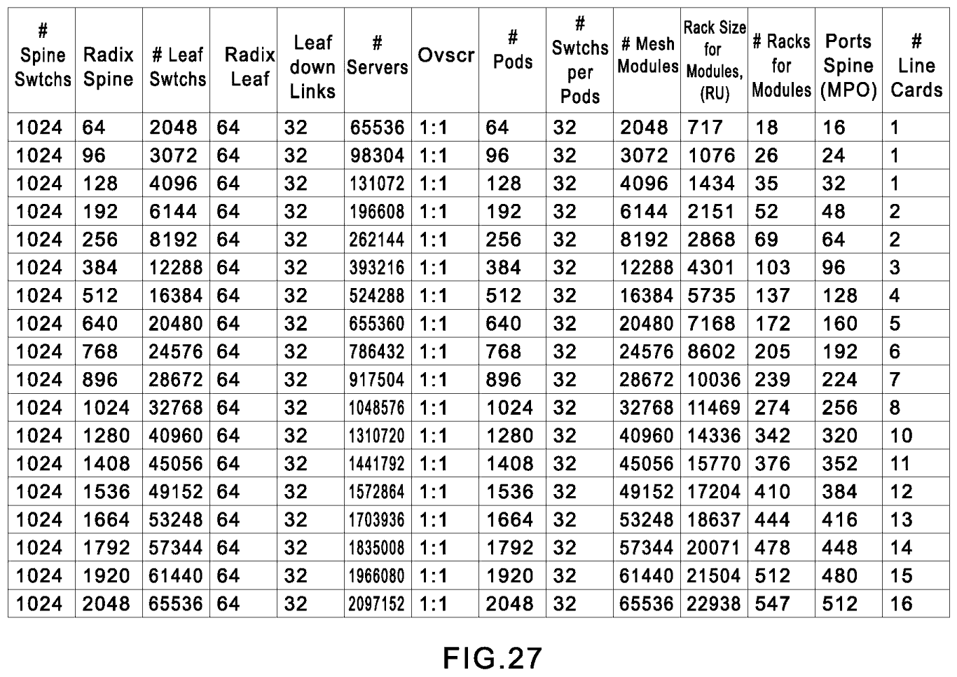

In FIG. 18, the second layer Spine to Leaf switches is implemented using modules 400. Since each Spine switch needs to connect only to one Leaf switch in the POD, there are 32×256=8192 ports that can be arranged in 512 modules 400, as shown in FIG. 19. The interconnection method for the Leaf and Spine switches is shown in FIG. 20 and FIG. 21, respectively. Clearly, due to rack space constraints, the stack of modules needs to be installed in several racks. Following the method described above, the uplinks of the Leaf switches in each POD populate the modules horizontally. For example, four MPO uplinks of the first Leaf switch from POD 1, which are L1p1, L1p1, L1p1, and L1p1, occupy the first MPO ports of the first module 400. Four MPO uplinks of the Leaf switch 16 from POD 32, which are L16p32, L16p32, L16p32, and L16p32, occupy the last four MPO ports of the last module 400 in the stack. From the opposite side of the stack, the columns of the module stack connect to the linecard MPO ports of the Spine switches. For example, as shown in FIG. 20, the linecard MPO ports of the Spine switch 1, S1c1, connect to eight MPO ports of the first column of the stack. The MPO ports of the second linecard of the same switch, S1c2, connect to eight MPO ports of the second column of the stack. The MPO ports of the 16^{th} linecard of the last Spine Switch, S16c16, connect to eight ports of the last column of the stack.

This three-layer fabric, with 256 Spine (or 16 chassis with 16 linecards) and 512 Leaf switches, requires 256 modules 400 with equivalent rack space equal to or smaller than 90 RU. The method to scale this network, with an oversubscription of 3:1 and 1:1 and the required number of modules 400 and rack space, is shown in Tables V and VI.

In general, modules 400 and the disclosed method of interconnection for two and three-tier FCNs simplify the deployment of the optical networks of different sizes and configurations. The risk of interconnection errors during the deployment is highly reduced since the groups of cables representing uplinks/downlinks for the same switches are connected in close proximity, and also due to the high degree of mesh in the networks. For example, in FIG. 19, all L1p1 connections, where i is the Leaf uplink index ranging from 1 to 4 and j the POD index ranging from 1 to 32, are interchangeable. During the network deployment, an unplanned change from L1p1 to L1p2, L1p1 to L1p3, L1p1 to L1p4, or in general any combination inside that group, will not have an impact on the network operation. The topology will still connect all the Leaf switches from the PODs to the Spine switches with the same number of paths and identical allocated bandwidth. Similarly, in FIG. 20, all the Spines are interchangeable for any row, as can be derived from FIG. 9. The level of redundancy provided by the stack of modules 400 highly reduces the risk of fabric failures or performance degradation caused by errors in the interconnection.

While this invention has been described as having a preferred design, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

What is claimed is:

1. An Apparatus having a plurality of multifiber connector interfaces, where some of these multifiber connector interfaces can connect to network equipment in a network using multifiber cables comprising an internal mesh implemented in two tiers, wherein the first is configured to for rearrange and the second is configured to recombine individual fiber of the different fiber groups, further wherein the light path of each transmitter and receiver is matched in order to provide proper optical connections from transmitting to receiving fibers and wherein complex arbitrary network topologies can be implemented with at least 1/N less point to point interconnections, where N=number of channels per multifiber connector interface.

2. The apparatus of claim 1, wherein the apparatus is further configured to be stacked to provide two-tier or three-tier CLOS network topology of various spine and leaf switch radixes.

3. The apparatus of claim 1, wherein the apparatus is further configured to enable networks with different levels of oversubscription from 1:1 to 1:12.

4. The apparatus of claim 1, wherein the apparatus is further configured to be used to scale optical networks from eight to a hundred thousand switches.

5. The apparatus of claim 1, wherein the apparatus is further configured to provide redundant paths, reducing the risk of network failure due to interconnection errors.

6. The apparatus of claim 1, wherein the apparatus is further configured to have a small form factor that enables stacking of three modules in one RU, allowing the stacking of up to 132 modules per rack.

7. The apparatus of claim 1, further comprising external labels can provide interconnection maps of the network to portable devices when the labels are read by said label readers such as laser scanning or cameras.

8. The apparatus of claim 1, wherein the apparatus is further configured to distribute the traffic load of the switches efficiently.

9. The apparatus of claim 1, wherein the interconnection ports use multifiber connectors with 4 to 32 fibers.

10. The apparatus of claim 1, wherein the interconnection ports use multifiber connectors of different form factors, such as CS, SN, MPO, SN-MT, MMC.

11. The apparatus of claim 1, wherein each fiber interconnection can transmit signal of different wavelengths in a co-propagation and counter propagation (bidirectional) way.

12. A structured cabling system comprising a stack of fiber optic modules, wherein each module has a plurality of multifiber connector interfaces, and further wherein each module incorporates an internal mesh, implemented in two or more tiers for optimum rearrangement of groups of optical fibers, wherein the stack of modules can be used to deploy or scale various CLOS network topologies using less numbers of interconnections.

13. The structured cable system of claim 9, wherein the system is further configured to be used to scale optical networks from eight to a hundred thousand switches.

14. The structured cabling system of claim 9, wherein the system is configured to provide redundant paths, reducing the risk of network failure due to interconnection errors.

15. An apparatus comprising a plurality of optical connector adapters and optical fiber interconnecting cables therein, wherein said optical fiber cables are configured between said connector adapters to implement a network interconnection fabric between uplink switch port adapters and downlink switch port adapters in order to implement a network switching optical cabling interconnection function within said apparatus.

16. The apparatus of claim 12, wherein the apparatus is further configured to have an oversubscription of 1:1, 1:2, or 3:1.

17. A module box is configured to connect optical channels from switches or servers of a network, where a least some structure of the fabric complexity is implemented in each module box, where each module box has an internal configuration that shuffles input or output groups of cables as well as the individual channels (single or duplex fiber) inside each cable to optimize the combination of the optical channels of the fabric.

18. The apparatus of claim 17, wherein each fiber interconnection can transmit signal of different wavelengths in a co-propagation and counter propagation (bidirectional) way.
